(19) United States
(12) Patent Application Publication
(10) Pub. No.: US 2021/0398196 A1
(43) Pub. Date: Dec. 23, 2021

(54) METHOD AND PLATFORM FOR MANAGING GIFTS

(71) Applicant: COUPON SOLUTIONS, Herzele (BE)

(72) Inventor: Pieter DE TROYER, Herzele (BE)

(73) Assignee: COUPON SOLUTIONS, Herzele (BE)

(21) Appl. No.: 17/289,779

(22) PCT Filed: Oct. 31, 2019
(86) PCT No.: PCT/IB2019/059333

§ 371 Date: Apr. 29, 2021

(30) Foreign Application Priority Data
Oct. 31, 2018 (BE) 2018/5765
Jun. 19, 2019 (BE) 2019/5398

(51) Int. Cl. G06Q 30/06; G06Q 20/32; G06Q 20/40; G06Q 40/02; G06F 16/9537

(52) U.S. Cl. CPC G06Q 30/0637; G06Q 20/322; G06Q 20/4037; G06F 16/9537; G06Q 40/02; G06Q 30/0623; G06Q 20/3276

(57) ABSTRACT

The present invention relates to a computer-implemented method for managing establishment-linked beverage gifts or gifts between different users, which users are registered with an account on a mobile application executable on a mobile device with a display.

### TECHNICAL FIELD

The invention relates to an improved computer-implemented method for managing gifts, with a specific application to beverage gifts as a preferred embodiment.

### PRIOR ART

The applicant aims to provide a computer-implemented method for managing establishment-linked gifts or beverage gifts between different users via a mobile application. On the one hand, it was noted that there is currently no valid system on the market that is suitable for this purpose, and that related systems, such as Tsjing®, which has since been discontinued, focus on the sale of individual items, which addresses many other problems. The applicant further notes that the method is transferable to applications other than gifts of drinks, and therefore also more generally to food, but even to the wider application of general coupons for a particular store or branch, without (or with limited) narrowing to certain products.

A first object of the present invention is to securely transfer a gift by a first user to a second user (typically another, but may just as well be the same). It is crucial here that the gift cannot be intercepted or consumed by a third party who is not entitled to it.

A second object of the present invention is to enable a simple, specific way 25 (establishment-linked) of remotely gifting a certain refreshment (drink, food or other) to a user, in which the person who effectively takes care of the refreshment (manager of the establishment, ‘validator’) can read in and process all necessary information automatically.

An additional object is the simple management of costs incurred during a group visit (two or more users) to an establishment without the need for cash transactions. In this way it is no longer necessary to create a ‘pot’, to calculate who should pay what to whom, or to look for change when paying between the various parties.

The prior art includes documents US 2014/095218 and US 2014/129392, but these fall short in the flexibility of passing on gifts.

The present invention aims to solve at least some of the problems mentioned above.

### SUMMARY OF THE INVENTION

The invention relates to a computer-implemented method for managing establishment-linked gifts between different users, the method comprising the following steps:
a. receiving and storing information in a central server from a first user, which first user is registered with an account on a mobile application, which application is executable on a mobile device with a display, regarding a new gift for a second user, which information is provided via a mobile device where the first user is logged into the mobile application via their account, which information includes at least the following data:
   i. identification data of the first user, preferably a username of their account for the mobile application and/or telephone number, preferably wherein the identification data of the first user is automatically provided by the mobile application;
   ii. identification data of the second user, preferably a username of their account for the mobile application and/or telephone number of the second user, which identification data of the second user is provided by the first user;
   iii. establishment for validating the beverage gift or gift, the establishment being selected by the first user from a predetermined list of establishments from the central server;
   iv. gift data of the beverage gift or gift comprising at least quantity, and optionally identification, of gifted refreshment units, the identification of the gifted refreshment units being selected from a predetermined refreshment list from the central server by the first user, the predetermined refreshment list being dependent on the selected establishment, and wherein it is verified that the first user has a credit of refreshment units for the selected establishment prior to the beverage gift or gift on their account on the mobile application that is at least as large as the number of refreshment units of the beverage gift or gift;
   wherein the gift data is provided after selecting the establishment;
b. reducing the credit of the first user for the selected establishment by the number of gifted refreshment units;
c. after receiving the information about the beverage gift or gift for the second user, detecting from the central server the logging in of the second user into their account on the mobile application;
d. upon detection of the logging in of the second user, sending from the central server the beverage gift or gift data to the mobile device on which the second user is logged in;
e. on the basis of an order for refreshments at the establishment by the second user, by a display device on which an account is logged in that is associated with the establishment, generating an optical, machine-readable representation, preferably a QR code, which representation is displayed machine-readable for a mobile device on a display of the establishment, and which representation can be uniquely validated by a mobile device on which the account of the second user is logged in, the generated representation comprising information about the number of refreshments of the order, and the type of refreshments of the order;
f. reading in the optical representation via the mobile application on a mobile device with video capacity on which the account of the second user is logged in;
g. processing the optical representation on the mobile device on which the second user is logged in, the number of refreshment units associated with the order and/or the number of refreshments and type of refreshments being displayed on the mobile device, whereby approval is requested from the second user prior to crediting the number of refreshment units from the account of the second user to the account of the establishment;
h. after approval from the second user, communicating to the central server of the approval, wherein the credit of the second user for the selected establishment is reduced by the number of refreshment units of the order;
i. reporting the approval to the account of the second user and the account of the establishment, as well as updating the credit of the second user.

As indicated, the gifts in a preferred embodiment refer to foodstuffs (wherein the establishments are eating and/or drinking establishments, such as cafes, bars, tearooms, restaurants, brasseries, festivals, etc.), and in the most preferred to beverage gifts (where the establishments are drinking establishments, such as cafes, bars, tearooms, restaurants, brasseries, festivals, etc.).

It should be noted, however, that the term ‘gifts’ should be understood in its broadest sense, such as a voucher or coupon, for use in a particular establishment (or particular chain). In this interpretation, the ‘refreshment units’ can thus amount to a number of credits on the one hand (expressed in a specific currency unit or in establishment-linked units or not), but on the other hand this can also amount to specific products of the establishment. In the following, in the above embodiment/interpretation of the invention, the term ‘beverage gifts’ can therefore be considered equivalent to ‘gifts’.

A specific example to which the working methods apply is, for example, for wedding lists, where certain gifts can subsequently be passed on (‘regifting’).

In a more specific embodiment, they are beverage gifts (and/or food gifts), and matching establishments.

Note here that (both in the first and in the second aspect of the invention) steps a, b, c and d must be carried out in the order mentioned, and can be performed at most simultaneously or partially simultaneously.

### BRIEF DESCRIPTION OF THE DRAWINGS

FIG. 1A-F shows a flow for the sub-method according to the first aspect of the invention of creating a new gift.

FIG. 2A-D shows a flow for the sub-method according to the first aspect of the invention of calling up and validating a gift.

3A-D shows a flow for the sub-method according to the first aspect of the invention of creating a new gift according to a preferred embodiment of the invention.

FIG. 4A-E shows a flow for the sub-method according to the first aspect of the invention of calling up and validating a gift according to a preferred embodiment of the invention.

FIG. 5A-F shows a flow for the sub-method according to the second aspect of the invention of creating a new gift.

FIG. 6A-D shows a flow for the sub-method according to the second aspect of the invention of calling up and validating a gift.

### DETAILED DESCRIPTION

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, ‘a’ and ‘the’ refer to both the singular and the plural, unless the context presupposes otherwise. For example, ‘a segment’ means one or more segments.

The terms ‘comprise’, ‘comprising’, ‘consist of’, ‘consisting of’, ‘provided with’, ‘have’, ‘having’, ‘include’, ‘including’, ‘contain’, ‘containing’ are synonyms and are inclusive or open terms that indicate the presence of what follows, and which do not exclude or prevent the presence of other components, characteristics, elements, members, steps, as known from or disclosed in the prior art.

In a specific embodiment, the term ‘establishments’ refers to business enterprises where certain goods are sold. In a more specific embodiment, these are eating and/or drinking establishments or hospitality industry (cafe, restaurant, tearoom, brasserie, hotel, etc.) where the food and/or beverage is consumed on the spot, and in an even more specific embodiment, this can be narrowed down to one industry (for example, cafes only and the like).

In a more general embodiment, ‘establishments’ generally refer to business enterprises where products are offered and/or sold. In addition, the aforementioned businesses can be virtual (Amazon and the like).

In a first aspect, the invention relates to a method according to claim 1. A first user hereby has the option of, from their account on the mobile application on their mobile device, typically a smartphone or the like, sending a gift to a second user (whether or not different from the first user). A first advantage here is the possibility to provide others with a gift remotely in a certain establishment, and preferably at a certain festival. This can either be focused on the known presence (or future known presence) of the second user in said establishment, or can also be an encouragement for the second user to visit said establishment to consume the gift. To initialise the gift, the first user must provide the necessary information, which on the one hand makes the gift traceable (both for possible reimbursement and to inform the second user), but also secure, in the sense that the gift can only be consumed by the second user. Logically, the content of the gift can also be recorded by the first user. This is typically done by selecting the establishment where the gift is to be validated (consumed), from a predefined list of establishments, which are registered with the mobile application as an establishment. This can be done by searching the list by name of the establishment, by location, by proximity to the first user or from a certain point. In a possible embodiment, under certain circumstances (for example between users sharing location with each other via the mobile device, and/or via the mobile application itself), it can even happen on the basis of (proximity to) the location of the second user.

Following the selection of the desired establishment, the mobile application can optionally request a refreshment list from the central server, which list is associated with said establishment. This list comprises a list of possible refreshments (typically defined by the establishment), as well as preferably the price (per item, per kg, per ten, etc.). In this list, the first user can then indicate which refreshments and how many they wish to gift the second user. Alternatively, however, one can simply work with a number of refreshment units that are typically equivalent to a fixed monetary value, the first user choosing to provide X number of refreshment units to the second user.

Additionally, identification data of the second user is entered by the first user. The second user can be selected from an already existing list (for example ‘friends’, or imported from telephone list/Facebook/other social media), or selected on the basis of username and/or telephone number of the second user.

It is important to note here that the second user, the recipient, does not necessarily have to have an account for the mobile application, since the gift only becomes validatable when the recipient logs in to the application. In the meantime, the data on the gift is stored on the server associated with the telephone number of the second user. In this sense, the second user who receives a gift based on their telephone number that is not linked to an account, can get a notification (e.g. via text message, email and/or other media) about this (the notification can optionally also indicate how they can download the application and/or create an account). The notification may also provide certain information about the gift, for example one or more of the following: first user (giver), establishment for validating the gift, (complete or incomplete) gift data, deadline for validation, etc.

The identification data of the first user is also provided with the information associated with the gift, and is typically provided automatically by the mobile application.

All the foregoing information is delivered to a central server, typically via a wireless internet connection of the mobile device. The central server stores the information under the same virtual entity, namely the gift involved. Preferably, the user will also pay automatically when sending the information, preferably via an in-account credit line.

Note that the execution (validation) of monetary transactions is generally known through optical recognition, such as via QR codes. For this reason, the current document will not elaborate on this, since these techniques are known and have not been specially adapted to the current application.

In a preferred embodiment, upon logging in to an account, the information regarding all beverage gifts or gifts linked to said account is retrieved from the central server again, preferably wherein the information is retrieved again when specifically requesting the information from said account. By updating the information, on request and/or automatically, a quasi-real-time overview can always be kept of it, which ensures that transactions are possible in the short term (also because transactions are conducted directly between accounts, and not between bank accounts or such), and which also prevents the ‘expiration’ of the gifts.

The term ‘beverage gifts’ can refer to a very specific designation of type and number of refreshments that a user wishes to transfer to a second user, but can also refer only to the number of refreshments in the form of a credit, where a refreshment has a single, fixed credit value (see drink vouchers), and a giver chooses how many refreshments should be transferred, after which a recipient can choose how these are validated. In particular, the second interpretation is the one that is most preferred in the present invention, where a giver wishes to transfer a number of ‘vouchers’ to a recipient, without linking to it a particular refreshment that limits the recipient.

However, it is to be understood that in this document the term ‘beverage gift’ and ‘beverage gifts’ may be equivalent to ‘gift’ or ‘gifts’, without the link to drinks, as previously indicated. In the following, the terms ‘beverage gift’ and ‘beverage gifts’ will therefore be used in which the broad interpretation represents a first embodiment, and the narrow interpretation refers to a preferred embodiment.

‘All gifts or beverage gifts linked to said account’ can on the one hand be both the gifts or beverage gifts in which said account is that of a first user (giver) and the gifts or beverage gifts in which said account is that of a second user (recipient). Alternatively, this only applies to the beverage gifts or gifts where the account is that of a second user. A still further alternative may be a request from the account for once again retrieving the information from all beverage gifts or gifts linked to said account, the account being that of a second user; and a request can be made from the account to once again retrieve the information from all beverage gifts or gifts linked to said account, the account being that of a first user.

In a preferred embodiment, the establishments from the predetermined list are provided with one or more associated accounts, and wherein upon validation of a generated representation by a mobile device on which an account is logged in that is associated with the establishment, the validation of said beverage gift or gift is sent to the central server and the validation with associated validation data is stored with the information regarding said beverage gift or gift.

Such an account that is linked to an establishment has a number of additional options compared to the ‘regular’ user accounts. Such accounts may also not have a number of options that regular user accounts do have, since such a ‘master account’ is actually linked to a commercial entity, and therefore has certain limitations. In general, a master account is suitable for generating representations that contain information about the number of refreshments of an order (and optionally the type of refreshments). However, representations can only be validated if there are sufficient credits on the account of a validating user that are linked to said establishment (if they are for another establishment, an error message typically indicates that it is the wrong establishment, and the gift not validated and therefore remains ‘open’ on the central server). Upon validation of an order for a correct master account by a user with sufficient credits, the validation is sent to the central server, and the validation data is stored with the information of the gift, which is then closed. The validation data is typically time, identification data of the master account (for example with multiple master accounts associated with one establishment), content of the validated gift, etc.

In a preferred embodiment, the second user can partially accept a received gift to be included in their credit, namely in terms of gift data and in particular the number and/or identification of gifted refreshments, for validation. The already existing gift is hereby adjusted to the selected gift data.

In a preferred embodiment, a user can initialise a new beverage gift or gift via the mobile application by providing said information regarding the new beverage gift or gift via the mobile application, said information further comprising: expiry date of the beverage gift or gift and/or validity period of the beverage gift or gift; or where a new beverage gift or gift is automatically provided with a predetermined expiry date and/or predetermined validity period of the beverage gift or gift, wherein this expiry date and/or validity period is dependent on the establishment of the beverage gift or gift and/or the time of initialising the beverage gift or gift.

By making it possible to add a final validation date to the gift, for example, it can be ensured that givers get their money back over time if a gift was not used, so that credits do not remain outstanding. In addition, this also gives a greater incentive for the recipient to use the gift, which is certainly interesting for gifts that are, for example, given as advertising (for example, by operator establishments).

In a preferred embodiment, an account associated with an establishment from the predetermined list of establishments, is adapted to be linked to a digital accounting system, whereby a validation of a beverage gift or gift to said account of the establishment is automatically transmitted to the digital accounting system, which is further provided with the gift data. The advantages of such a linked system are obvious, and furthermore prevent possible fraud, and can serve as an additional confirmation to the tax authorities that all income is declared.

In a preferred embodiment, a unique username and a unique telephone number are associated with each account, preferably with a bank account number associated with each account. Note that the credit line of an account can be supplemented via multiple channels and different bank accounts (there is actually little or no limitation herein), but the associated bank account number is used for (full or partial) refunds of credits, expired unvalidated gifts, etc. In the first instance, a refund of expired/unvalidated gifts will happen to a credit from the user in question who created the gift. However, it is preferably possible from the mobile application to repay existing credits to the associated bank account.

In a preferred embodiment, a user pays for their own initialised beverage gifts or gifts via a virtual account-bound credit, preferably in advance, which credit can be provided with funds electronically.

An internal credit line associated with a user account guarantees, on the one hand, to the operator of the establishment that the funds are available for the gift. By providing funds on the credit line, the giver (first user) is also assured that they will be able to use it (for themselves or others), instead of being dependent on a mobile banking application, which will then still have to be opened in the original application to make payments.

In a preferred embodiment, a real-time overview of non-validated beverage gifts or gifts for said account can be requested from the central server via an account, preferably with a historical overview of validated beverage gifts or gifts for said account being requested from the central server.

This improvement is especially useful for a user to keep an overview of open gifts, preferably with information about a possible duration or expiry date thereof.

In a preferred embodiment, a real-time overview of non-validated beverage gifts or gifts for said establishments can be requested from the central server via an account associated with an establishment from the predetermined list of establishments.

As an operator of an establishment, it may be useful to encourage certain users to use a gift so that it is not lost, but also to see to what extent self-offered gifts are used or not by the recipients. In addition, it also provides the operator with an overview of the income to be expected for the coming period.

In a preferred embodiment, when selecting the establishment upon initialising a beverage gift or gift by a user, the user can search the predetermined list based on geographic location, preferably city or town.

In a preferred embodiment, via an account associated with an establishment from the predetermined list, the predetermined refreshment list may be edited for said establishment, wherein editing comprises adding, modifying and deleting refreshments on the refreshment list, as well as adding, modifying and deleting of the price of the aforementioned refreshments.

In a preferred embodiment, a user may divide a non-validated beverage gift or gift with multiple gifted refreshments into separate beverage gifts or gifts, each comprising at least one gifted refreshment, the total number of gifted refreshments of the divided individual beverage gifts or gifts is at most equal to the number of gifted refreshments from the non-validated beverage gift or gift.

This option in particular can be particularly useful for spreading a gift over an entire evening. For example, a user can gift another user to 10 pints or cokes, but are of course not expected to cash them in at once, especially since it is not easy to meet up with 9 others by a certain deadline. In this way, for example, the recipient can select one or two refreshments from the gift, split them off and convert them into a new gift (or vice versa, split the rest and convert them into a new gift), which can even be passed on to a third user. Thus, it is possible to only use the desired refreshments in the desired number, and the other refreshments are not lost.

Furthermore, in a possible embodiment, multiple gifts for a particular user can also be merged into a single gift by the user. This can be done either locally, on the application and mobile device itself, or on the central server controlled from the application. Here, however, upon validation of the (provisional) new, merged gift, a new gift would be (definitively) created on the central server, and the merged gifts marked as validated on the central server.

In a preferred embodiment, the information regarding a beverage gift or gift further comprises a time stamp.

In a preferred embodiment, non-validated beverage gifts or gifts received on a first account can be passed, in part or in full, to a second account, thereby defining a new beverage gift or gift, wherein the refreshments to be transmitted and their number can be defined from the first account.

In a preferred embodiment, the first and second user can be the same user.

The biggest advantage of this is that a user can give themselves a certain budget in advance to consume, which on the one hand can impose a certain restriction on them, but on the other hand also allows them to operate completely cashlessly when visiting the establishment.

In a preferred embodiment, the validating party does not receive any information regarding the gift regarding the identity of the first user and/or the second user.

In the most preferred embodiment, the sending of the information by the first user is performed by a swipe movement on a display of the mobile device on which the first user is logged in with their account on the mobile application.

In the following, the invention is described by way of non-limiting examples illustrating the invention, and which are not intended or may be interpreted to limit the scope of the invention.

### Examples

### Example 1: Creating a New Gift

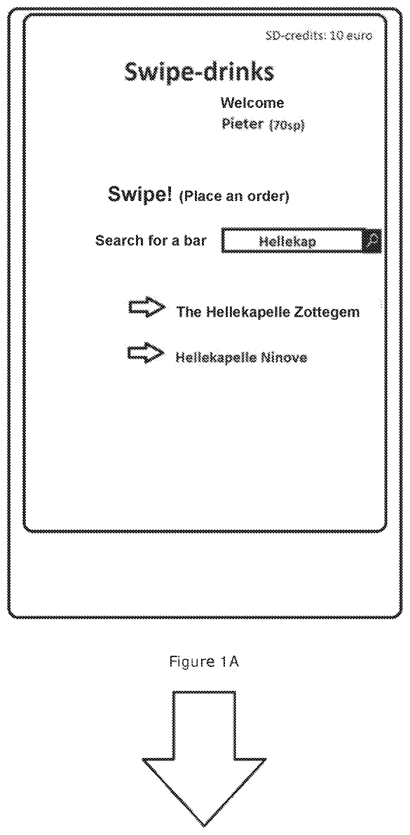

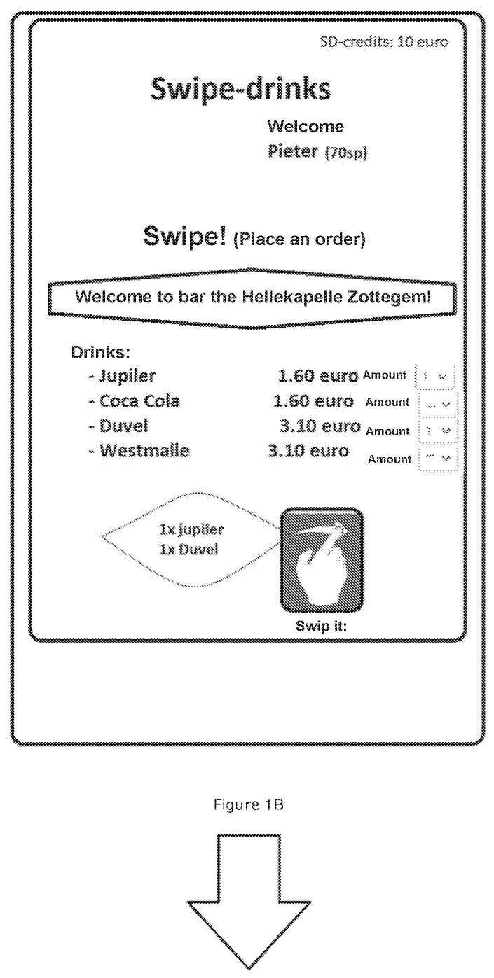

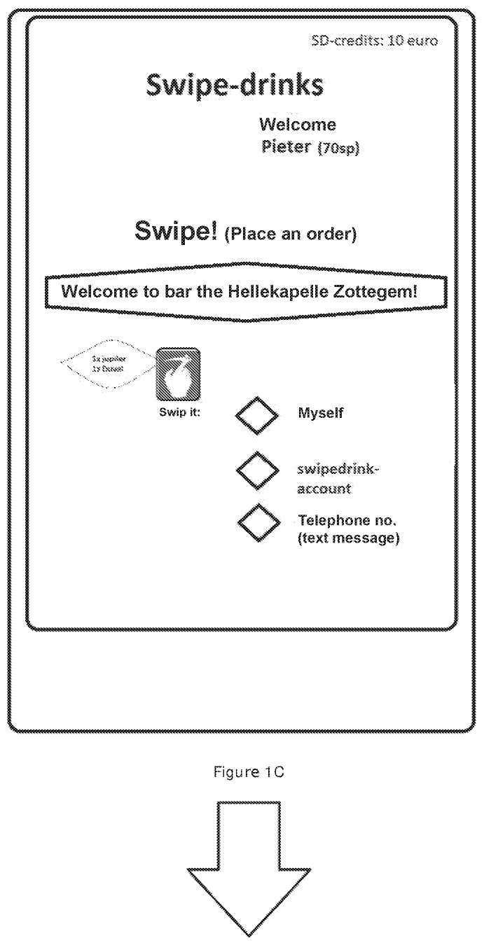

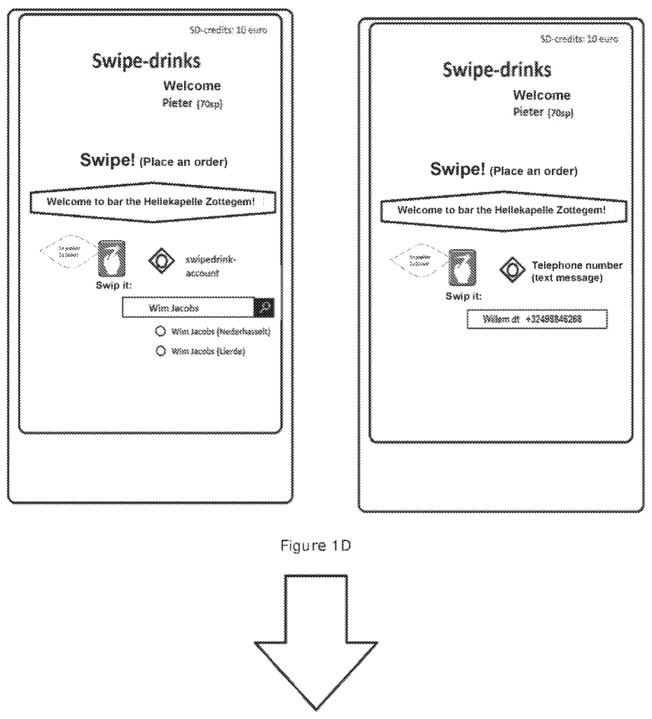

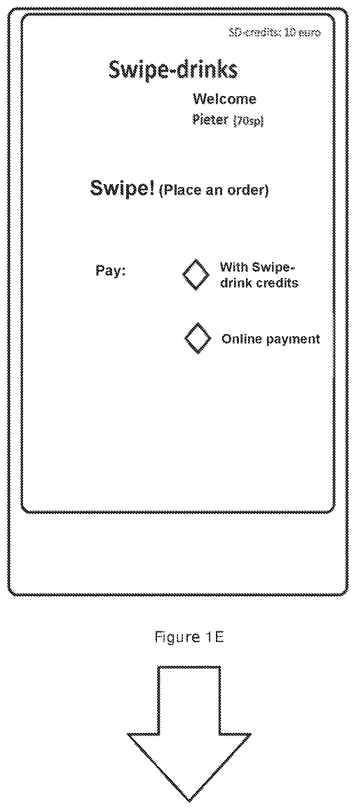

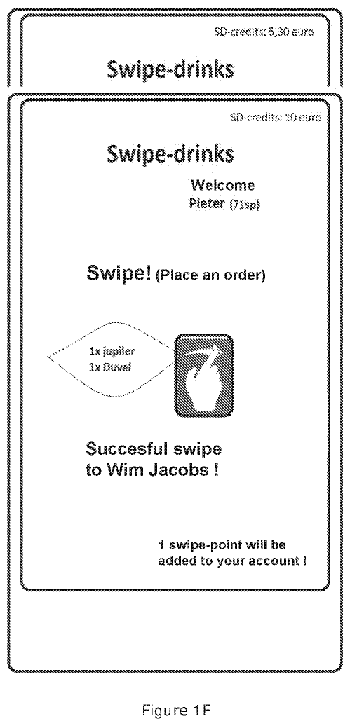

FIGS. 1A-B-C-D-E-F show an example of creating a new beverage gift or gift according to the method, specifically the steps of providing the information about the beverage gift or gift. In FIG. 1A, the user chooses an establishment by entering its name (in whole or in part), after which it can be searched for in the predetermined list of establishments, and corresponding entities are shown, from which the user can then select (or simply advance in case of only one hit for the search term). Once the establishment has been selected, the user ends up in an overview of the possible refreshments for the establishment, shown in FIG. 1B, which overview is predetermined for each establishment separately. Here, the user can choose which refreshments and how many they wish to gift.

In a next step, visible in FIG. 1C-D, the recipient or second user can be selected, wherein it can be chosen via one or more of the proposed criteria, namely: to themselves, via a username of an account of a user of the mobile application, or via a telephone number of a user. Preferably, only the first two options will be possible. The sender may still have to choose between multiple users who satisfy the same username, which can then be further distinguished based on other data, such as a specified location or telephone number.

Finally, in FIG. 1E, the method of payment can be chosen, via an online payment (mobile banking for example), or via a credit linked to the account.

Once this data is provided, the gift can be officialised, and the information passed on to the central server as a new beverage gift or gift (FIG. 1F).

### Example 2: Use of a Gift

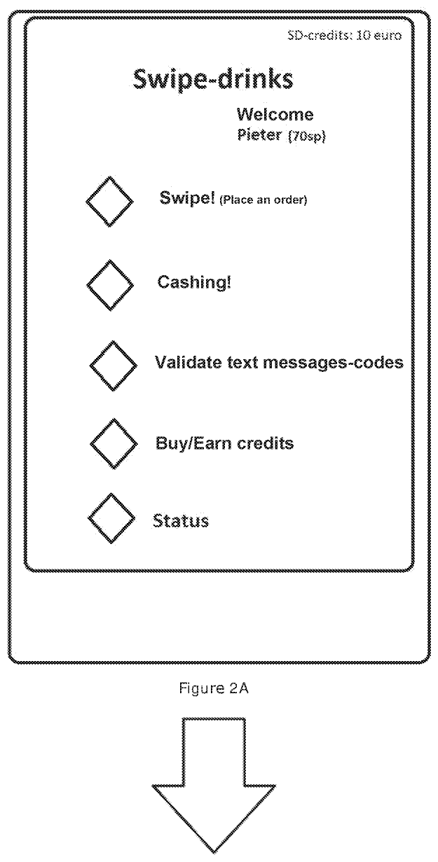

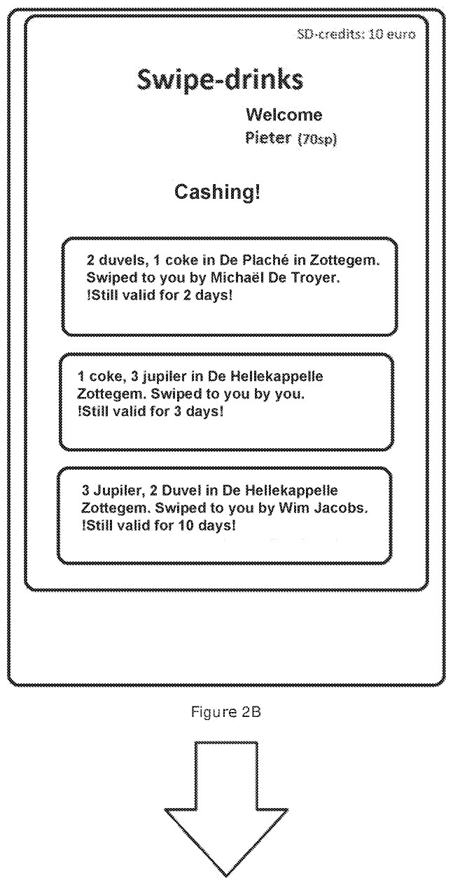

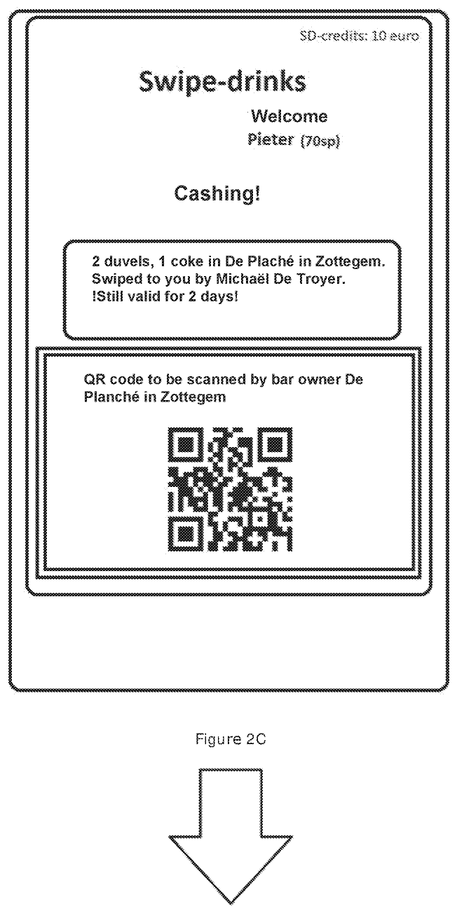

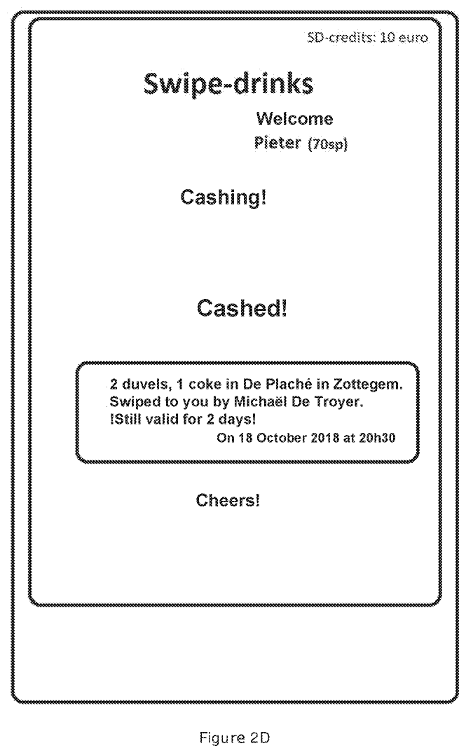

In a first user interface (FIG. 2A), the user can make a number of choices, including ‘redeem’. This brings the user to an overview of open gifts (FIG. 2B) for their account, with in this case further information such as gift data, identification data of the giver (first user), last date of use, and establishment for validation. The user can make a selection here, for example the first gift (FIG. 2C), the information about this being displayed. The user can request that the representation be generated, in this case a QR code that can (only) be read by the account of the establishment for validation. Confirmation follows after successful reading out (FIG. 2D).

The present invention should not be construed as being limited to the embodiments described above and certain modifications or changes may be added to the examples described without having to re-evaluate the appended claims. For example, the present invention has been described with reference to beverage gifts (in cafes, tearooms and the like), but it should be understood that the invention can be applied to, for example, general food gifts (extend application to restaurants as well) or more generally to coupons or vouchers in stores or store chains.

### Example 3: Creating a New Gift

FIG. 3A shows a first user interface of a first user, in which a number of establishments (festivals in this case) are listed by the user for which they wish to create (purchase) a number of refreshments. When one of the festivals (establishments) is selected, as ‘Rock Zottegem’ has been chosen in FIG. 3B, the available credit is visible at the festival (5 vouchers), with a number of options, such as providing the available credit (‘Purchase tokens’), as well as gift refreshments to a second user (‘Swipe Vouchers’). Finally, it is also possible to validate a refreshment (‘Place an order (redeem tokens at the bar)’).

FIG. 3C shows the display when choosing to pass on a gift to a second user. On the one hand, the number of refreshment units can be chosen that are to be gifted (‘2 tokens’). Note that in certain embodiments this can also be implemented by choosing specific types of refreshments and associated quantities. The beneficiary recipient or second user must then be selected. This can be looked up from a pre-existing list of ‘friends’ or ‘acquaintances’, but it can also be done via a general search function by name or other identification (customer number, telephone number, etc.) associated with the account of the second user, with the search performed on the full list of users. In this case a search was made for ‘Simon D’ with two hits appearing, one of which can then be referred to as the second user. Finally, the selected gift can be sent to the selected second user, as shown in FIG. 3D.

### Example 4: Use of a Gift

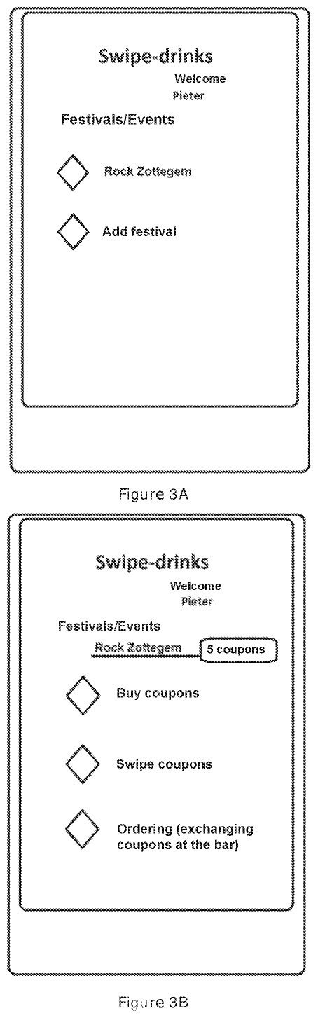

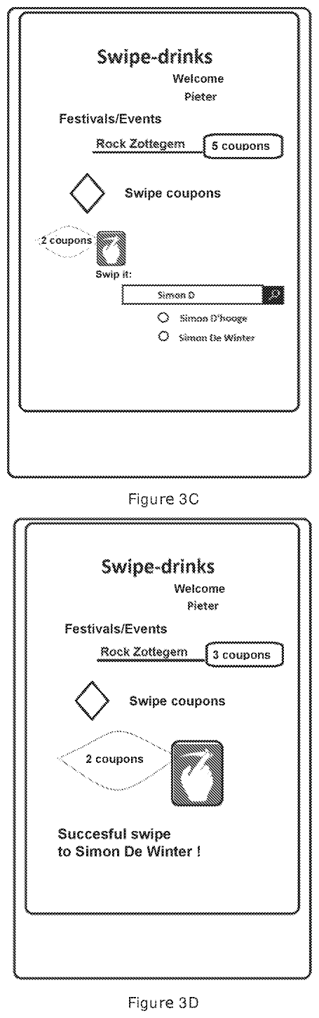

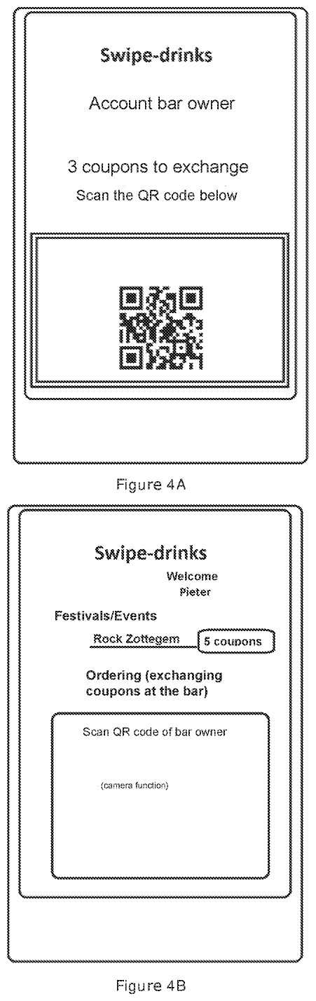

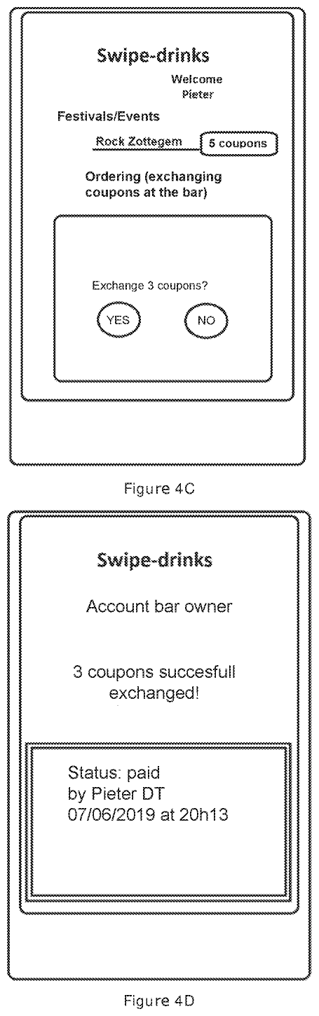

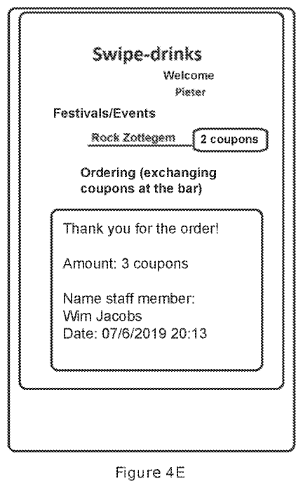

From the perspective of a manager or person with access to an account linked to an establishment, this can be entered for a specific order, whereby the number of refreshment units equivalent to the order can be calculated automatically or manually and an optical, machine-readable representation, in this case a QR code, is generated that contains this info on a display linked to the account of the establishment. This is visible in FIG. 4A, where in addition to the QR code itself, the number of refreshment units is also visually displayed for verification for the user who is validating.

From the user side (FIG. 4B), we see the possibility to validate the QR code. This happens after choosing ‘Place an order’ from an earlier menu (see FIG. 3B), where the camera of the user's electronic device is controlled, and with it the QR code can be read. After being read in, the information from the QR code is converted and communicated to the user, whereby at least the number of refreshment units linked to the order is visually communicated on the user's electronic device (‘Redeem 3 tokens’), after which they can explicitly approve or reject (‘Yes’ or ‘No’) the order, as shown in FIG. 4C. Upon approval, this is communicated (typically via Wi-Fi) to the central server, which then also communicates this to the provider of the QR coder (device on which the festival account is logged in), which receives a notification thereof with further details such as name, time and information about the number of refreshment units, as shown in FIG. 4D. Conversely, as seen in FIG. 4E, the user who validates the order can also be notified of the approval, with the information, whereby further information about the identity linked to the festival's account can be displayed, such as the name.

### Example 5: Creating a New Gift

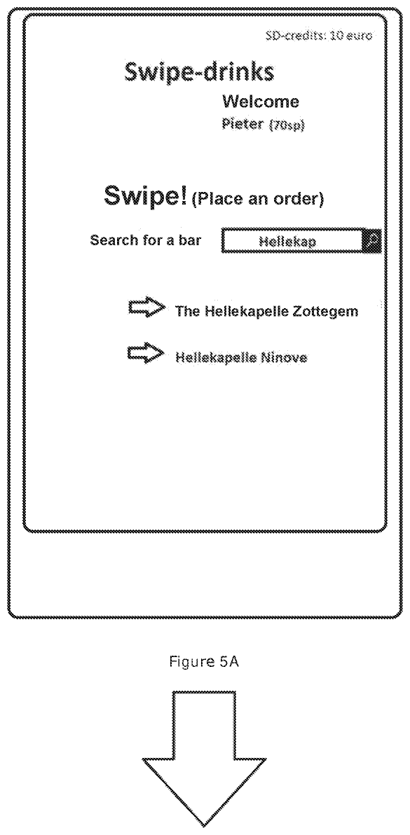

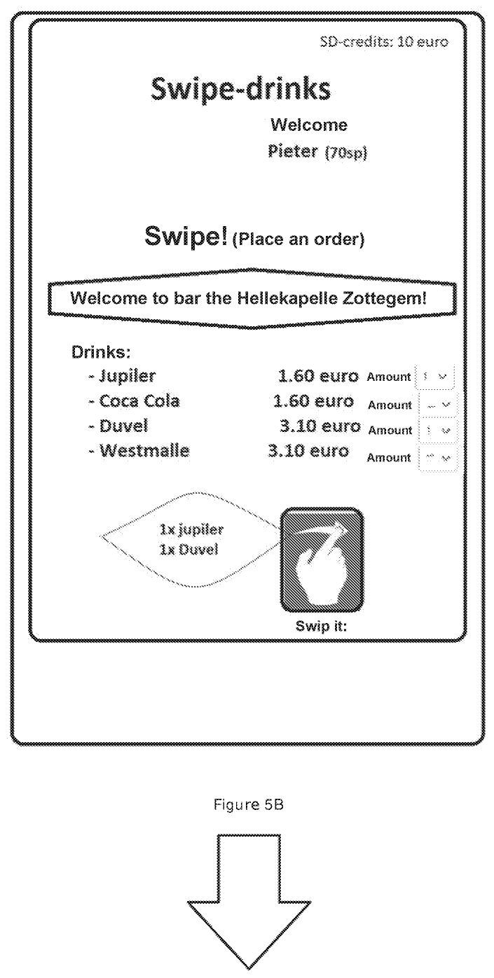

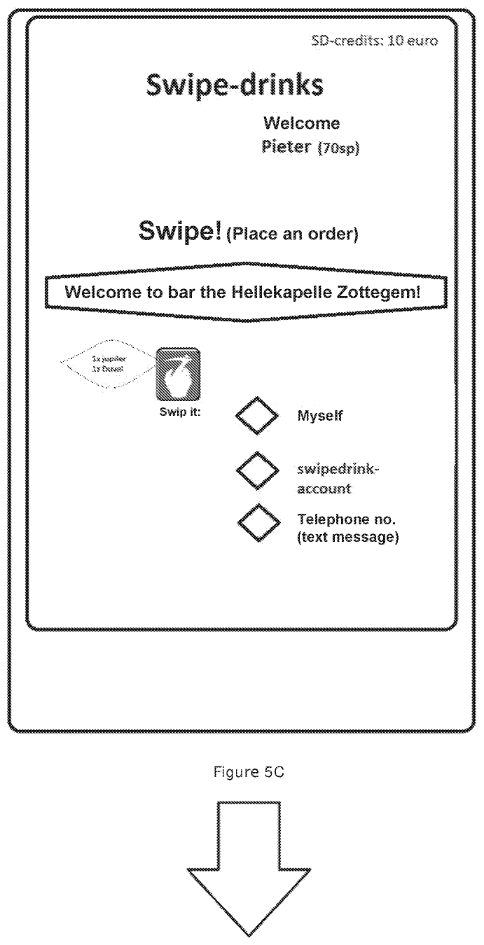

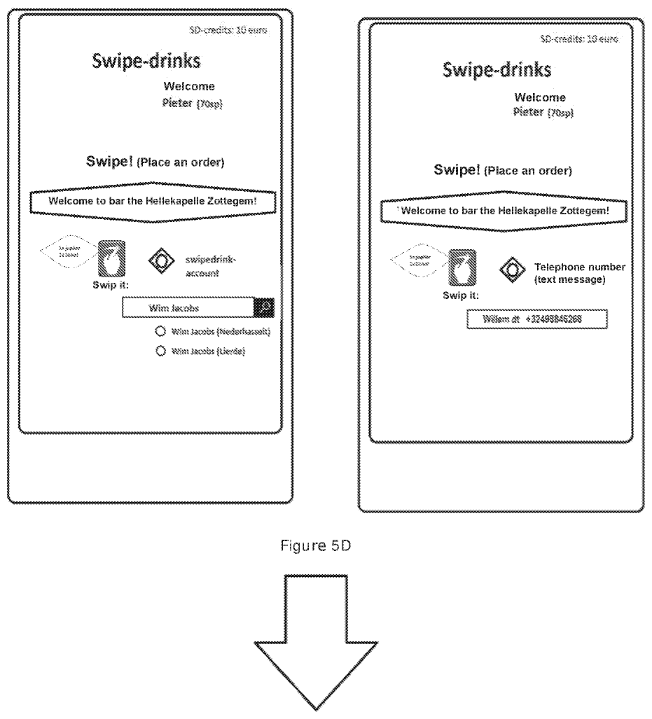

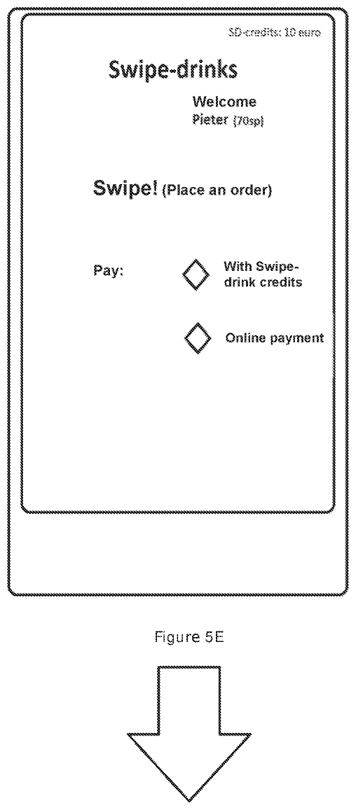

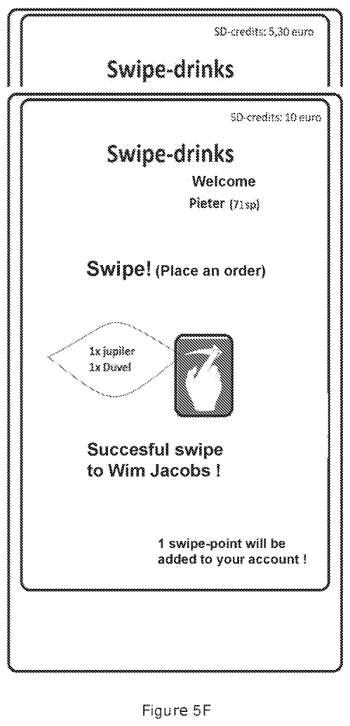

FIGS. 5A-B-C-D-E-F show an example of creating a new beverage gift or gift according to the method, specifically the steps of providing the information about the beverage gift or gift. In FIG. 5A, the user chooses an establishment by entering its name (in whole or in part), after which it can be searched for in the predetermined list of establishments, and corresponding entities are shown, from which the user can then select (or simply advance in case of only one hit for the search term). Once the establishment has been selected, the user ends up in an overview of the possible refreshments for the establishment, shown in FIG. 5B, which overview is predetermined for each establishment separately. Here, the user can choose which refreshments and how many they wish to gift.

In a next step, visible in FIG. 5C-D, the recipient or second user can be selected, wherein it can be chosen via one or more of the proposed criteria, namely: to themselves, via a username of an account of a user of the mobile application, or via a telephone number of a user. Preferably, only the first two options will be possible. The sender may still have to choose between multiple users who satisfy the same username, which can then be further distinguished based on other data, such as a specified location or telephone number.

Finally, in FIG. 5E, the method of payment can be chosen, via an online payment (mobile banking for example), or via a credit linked to the account.

Once this data is provided, the gift can be officialised, and the information passed on to the central server as a new beverage gift or gift (FIG. 5F).

### Example 6: Use of a Gift

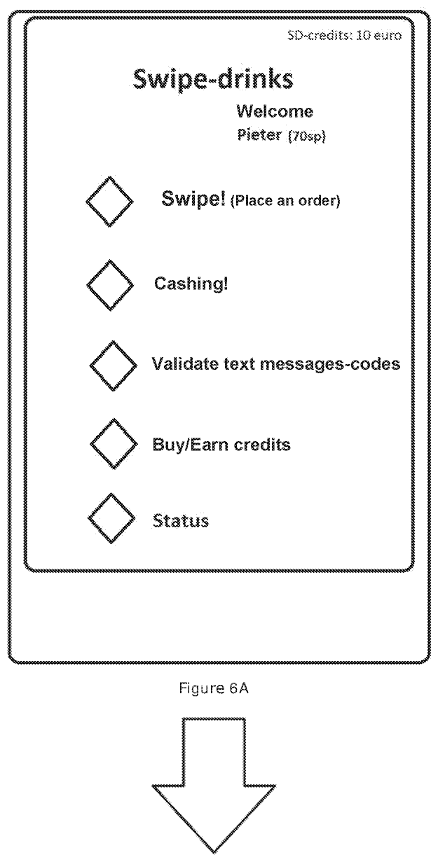

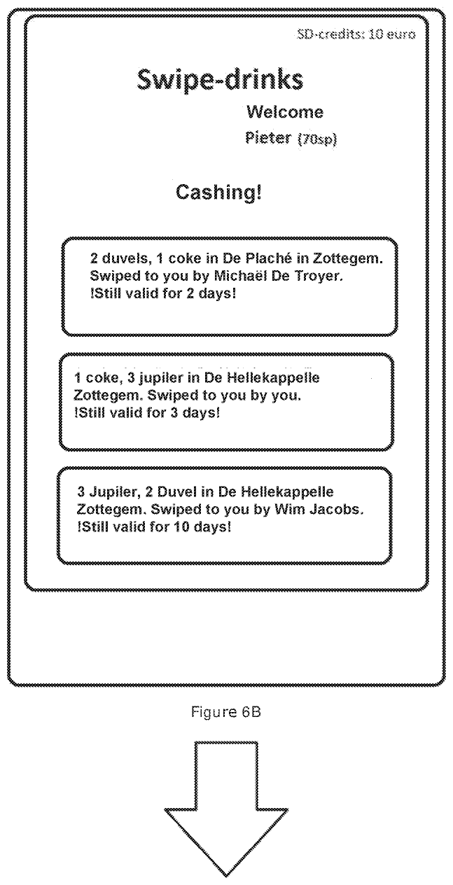

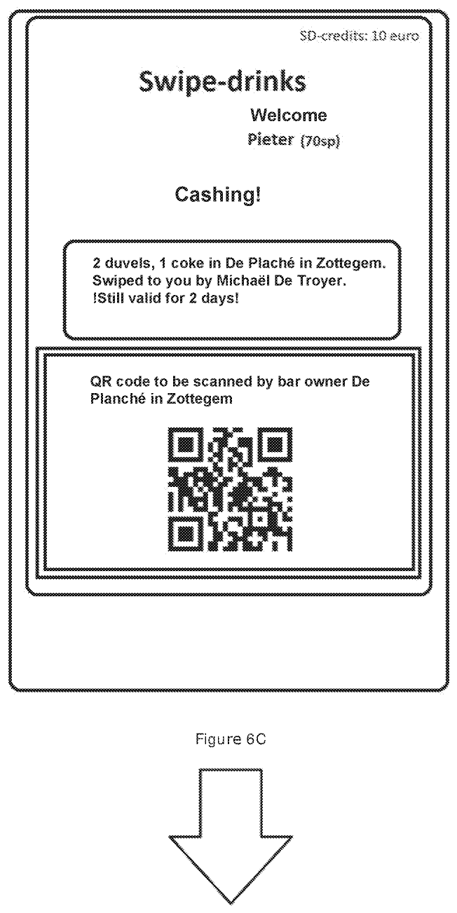

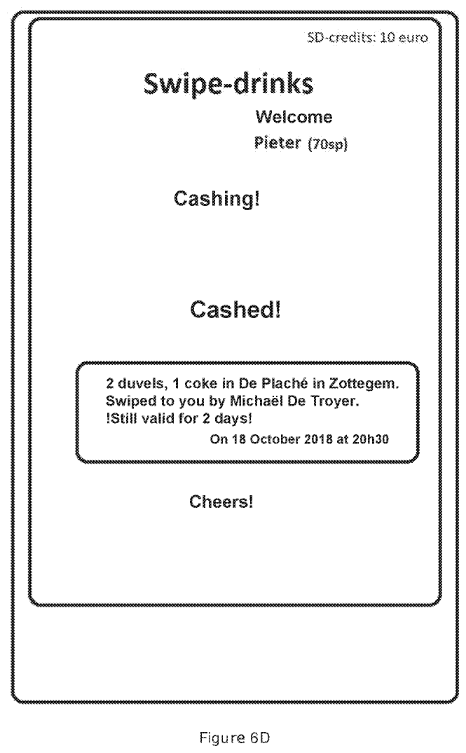

In a first user interface (FIG. 6A), the user can make a number of choices, including ‘redeem’. This brings the user to an overview of open gifts (FIG. 6B) for their account, with in this case further information such as gift data, identification data of the giver (first user), last date of use, and establishment for validation. The user can make a selection here, for example the first gift (FIG. 6C), the information about this being displayed. The user can request that the representation be generated, in this case a QR code that can (only) be read by the account of the establishment for validation. Confirmation follows after successful reading (FIG. 6D).

The present invention should not be construed as being limited to the embodiments described above and certain modifications or changes may be added to the examples described without having to re-evaluate the appended claims. For example, the present invention has been described with reference to beverage gifts (in cafes, tearooms and the like), but it should be understood that the invention can be applied to, for example, general food gifts (extend application to restaurants as well) or more generally to coupons or vouchers in stores or store chains.

### Second Aspect of the Invention:

In the second aspect, the present invention relates, among other things, to:

### Method:

1. Computer-implemented method for managing establishment-linked beverage gifts or gifts between different users, the method comprising the following steps:
   a. receiving and storing information in a central server from a first user, which first user is registered with an account on a mobile application, which application is executable on a mobile device with a display, regarding a new beverage gift or gift for a second user, which information is provided via a mobile device where the first user is logged into the mobile application via their account, which information comprises at least the following data:
      i. identification data of the first user, preferably a username of their account for the mobile application and/or telephone number, preferably wherein the identification data of the first user is automatically provided by the mobile application;
      ii. identification data of the second user, preferably a username of their account for the mobile application and/or telephone number of the second user, which identification data of the second user is provided by the first user;
      iii. establishment for validating the beverage gift or gift, the establishment being selected by the first user from a predetermined list of establishments from the central server;
      iv. gift data of the beverage gift or gift comprising at least the quantity and identification of gifted refreshments, wherein the identification of the gifted refreshments is selected from a predetermined refreshment list from the central server by the first user, the predetermined refreshment list being dependent on the selected establishment;
      wherein the gift data is provided after selecting the establishment;
   b. after receiving the information about the beverage gift or gift for the second user, detecting from the central server the logging in of the second user into their account on the mobile application;
   c. upon detection of the logging in of the second user, sending from the central server the beverage gift or gift data to the mobile device on which the second user is logged in;
   d. processing by the mobile application of the received information regarding the beverage gift or gift on the mobile device on which the account of the second user is logged in, whereby an optical, machine-readable representation, preferably a QR code or barcode, is generated on the basis of the received information, which representation is machine-readable for a mobile device on the display of the mobile device on which the second user is logged in, and which representation is uniquely validatable by a mobile device on which an account is logged in that is associated with the establishment of the information regarding the beverage gift or gift.
2. Computer-implemented method according to method 1 above, wherein, when receiving and storing information regarding a new beverage gift or gift in the central server, an account linked to the establishment for validating said new beverage gift or gift refreshment receives refreshment data regarding the new beverage gift or gift from the central server, said refreshment data at least comprising the gift data of said new beverage gift or gift, and preferably further the identification data of said second user, wherein based on the received refreshment data a keyhole is created on the central server and provided to the account linked to the establishment or a keyhole is created on the mobile device on which the account linked to the establishment is logged in, which keyhole is suitable for recognising the representation regarding the beverage gift or gift, thereby validating the beverage gift or gift.
3. Computer-implemented method according to any of the preceding methods 1 or 2, wherein the processing into the machine-readable representation is performed at the request of the second user.
4. Computer-implemented method according to any of the preceding methods 1 to 3, wherein generating the representation is dependent on the agreement of the identification data of the second user associated with the beverage gift or gift and the identification data of the account through which the representation is generated.
5. Computer-implemented method according to any of the preceding methods 1 to 4, wherein, when logging in to an account, the information regarding all beverage gifts or gifts linked to said account is retrieved again from the central server, preferably wherein the information is retrieved again when the information is specifically requested from said account.
6. Computer-implemented method according to any of the preceding methods 1 to 5, wherein the establishments from the predetermined list are provided with one or more associated accounts, and wherein, when reading in a generated representation by a mobile device on which an account is logged in which is associated with the establishment for validating the beverage gift or gift of the generated representation, the validation of said beverage gift or gift is sent to the central server and wherein the validation with associated validation data is stored with the information concerning said beverage gift or gift.
7. Computer-implemented method according to any of the preceding methods 1 to 6, wherein a user can initialise a new beverage gift or gift via the mobile application by providing said information regarding the new beverage gift or gift via the mobile application, said information further comprising: expiry date of the beverage gift or gift and/or validity period of the beverage gift or gift,
8. Computer-implemented method according to any of the preceding methods 1 to 7, wherein an account associated with an establishment from the predetermined list of establishments, is suitable to be linked to a digital accounting system, wherein a validation of a beverage gift or gift by said account of the establishment is automatically passed on to the digital accounting system, which is further provided with the gift data.
9. Computer-implemented method according to any of the preceding methods 1 to 8, wherein a unique username and a unique telephone number are associated with each account, and preferably wherein a bank account number is associated with each account.
10. Computer-implemented method according to any of the preceding methods 1 to 9, wherein a user prepays their own initialised beverage gifts or gifts via a virtual account-linked credit, which credit can be provided with funds electronically.
11. Computer-implemented method according to any of the preceding methods 1 to 10, wherein a real-time overview of non-validated beverage gifts or gifts for said account can be requested via an account from the central server, preferably wherein a historical overview of validated beverage gifts or gifts for said account can be requested from the central server.
12. Computer-implemented method according to any of the preceding methods 1 to 11, wherein a real-time overview of non-validated beverage gifts or gifts for said establishments can be requested via an account associated with an establishment from the predetermined list of establishments from the central server.
13. Computer-implemented method according to any of the preceding methods 1 to 12, wherein when selecting the establishment upon initialising a beverage gift or gift by a user, the user can search the predetermined list based on geographic location, preferably by city or town.
14. Computer-implemented method according to any of the preceding methods 1 to 13, wherein via an account associated with an establishment from the predetermined list, the predetermined refreshment list for said establishment can be edited, wherein editing comprises adding, changing and removing refreshments on the refreshment list, as well as adding, changing and removing the price of said refreshments.
15. A computer-implemented method according to any of the preceding methods 1 to 14, wherein a user can divide a non-validated beverage gift or gift with multiple gifted refreshments into separate beverage gifts or gifts, each comprising at least one gifted refreshment, the total the number of gifted refreshments of the divided individual beverage gifts or gifts being at most equal to the number of gifted refreshments of the non-validated beverage gift or gift to be divided.
16. Computer-implemented method according to any of the preceding methods 1 to 15, wherein the information regarding a beverage gift or gift further comprises a timestamp.
17. Computer-implemented method according to any of the preceding methods 1 to 16, wherein non-validated beverage gifts or gifts received on a first account can be passed on, partially or completely, to a second account, thereby defining a new beverage gift or gift, whereby the refreshments to be transmitted and their number can be defined from the first account.
18. Computer-implemented method according to any of the preceding methods 1 to 17, wherein the first and second user can be the same user.
Crucial to the method of the second aspect is that on the central server the information is not bundled into a validatable representation, and the representation is thus only generated on the mobile device on which the account of the second user is logged into the mobile application. This guarantees that the beverage gift or gift can only be validated by the effective recipient, and protects against potential abuses.

The method according to method 2 of the second aspect guarantees the unique link between user (‘second user’) of a beverage gift or gift and validator (establishment), and ensures that only the correct validator can validate the beverage gift or gift. The validator receives the necessary data on their account to create a digital keyhole for the beverage gift or gift specifically for ‘the key’ of the representation.

Preferably, the second user already receives the information regarding the gift on their account and/or mobile device, where the information can be stored (or simply forgotten and retrieved again at a subsequent log-in or request). It is only when explicitly requesting that the representation be generated that this happens, and the gift can subsequently also be validated.

Alternatively or additionally to the method 4 of the second aspect, the generation can further take place via account-specific data, which is requested separately from receiving the information about the beverage gift or gift from the central server.

The above is an additional step to protect the gift against a third party.

By updating the information according to method 5 of the second aspect, on request and/or automatically, a quasi-real-time overview can always be kept of it, which ensures that transactions are possible in the short term (also because transactions are conducted directly between accounts, and not between bank accounts or such), and which also prevents the ‘expiration’ of the gifts.

‘All gifts or beverage gifts linked to said account’ can on the one hand be both the gifts or beverage gifts in which said account is that of a first user (giver) and the gifts or beverage gifts in which said account is that of a second user (recipient). Alternatively, this only applies to the beverage gifts or gifts where the account is that of a second user. A still further alternative may be a request from the account for once again retrieving the information from all beverage gifts or gifts linked to said account, the account being that of a second user; and a request can be made from the account to once again retrieve the information from all beverage gifts or gifts linked to said account, the account being that of a first user.

Following method 6 of the second aspect, such an account which is linked to an establishment has a number of additional options compared to the ‘regular’ user accounts. Such accounts may also not have a number of options that regular user accounts do have, since such a ‘master account’ is actually linked to a commercial entity, and therefore has certain limitations. In general, a master account is suitable for reading in, and thereby validating, generated representations. However, only representations with a gift that are linked to said establishment (for validation) can also be validated effectively (if for another establishment, an error message typically indicates that it is the wrong establishment, and the gift is not validated and therefore remains ‘open’ on the central server). When validated by a correct master account, the validation is sent to the central server, and the validation data is stored with the information of the gift, which is then closed. The validation data is typically time, identification data of the master account (for example with multiple master accounts associated with one establishment), content of the validated gift, etc.

In a preferred embodiment according to the second aspect, a user with an account linked to an establishment from the predetermined list can provide refreshment data in the mobile application which this user is logged into, said refreshment data comprising at least identification of ordered refreshments from the predetermined refreshment list of the establishment, as well as the number of refreshments ordered. When reading in the generated representation of the ordering user, the information read out (specific identification and number of gifted refreshments) of the representation is compared with the refreshment data. Upon agreement, the transaction is then also validated, and the central server informed.

Alternatively, the user linked to an establishment can simply read in the generated representation without providing refreshment data in advance, and the linked user is then shown the gift data, specific identification and number of the gifted refreshments, preferably on a display of the mobile device on which the linked user is logged in.

The first embodiment according to the second aspect above provides a better alignment between what is ordered and what is validated, and serves rather for confirmation afterwards. The second form can serve as a way to easily place an order with an operator (which can certainly be useful in a noisy environment).

In a preferred embodiment according to the second aspect, the second user can partially select a received gift, namely in terms of gift data and in particular the number and/or identification of gifted refreshments, for validation. A representation is here generated based on the selected gift data. Subsequently, this information (preferably only upon validation, but it can also be in advance) is automatically delivered to the central server, where a new gift is generated and stored, which displays the ‘remaining’ gift based on the original gift data and the selected gift data. The already existing gift is hereby adjusted to the selected gift data.

In a preferred embodiment according to the second aspect, a user can initialise a new beverage gift or gift via the mobile application by providing said information regarding the new beverage gift or gift via the mobile application, said information further comprising: expiry date of the beverage gift or gift and/or validity period of the beverage gift or gift; or where a new beverage gift or gift is automatically provided with a predetermined expiry date and/or predetermined validity period of the beverage gift or gift, wherein this expiry date and/or validity period is dependent on the establishment of the beverage gift or gift and/or the time of initialising the beverage gift or gift.

By making it possible to add a final validation date to the gift, for example, it can be ensured that givers get their money back over time if a gift was not used, so that credits do not remain outstanding. In addition, this also gives a greater incentive for the recipient to use the gift, which is certainly interesting for gifts that are, for example, given as advertising (for example, by operator establishments).

The advantages of a linked system according to method 8 of the second aspect are self-evident, and moreover prevent potential fraud, and can serve as an additional confirmation to the tax authorities that all income is declared.

Note that the credit line of an account can be supplemented via multiple channels and different bank accounts (there is actually little or no limitation herein), but the associated bank account number is used for (full or partial) refunds of credits, expired unvalidated gifts, etc. In the first instance, a refund of expired/unvalidated gifts will happen to a credit from the user in question who created the gift. However, it is preferably possible from the mobile application to repay existing credits to the associated bank account.

An internal credit line associated with a user account guarantees on the one hand to the validator or operator of the establishment that the funds are available for the gift. By providing funds on the credit line, the giver (first user) is also assured that they will be able to use it (for themselves or others), instead of being dependent on a mobile banking application, which will then still have to be opened in the original application to make payments.

The improvement according to method 11 of the second aspect is especially very useful for a user to keep an overview of open gifts, preferably with information regarding a possible validity period or expiration date thereof.

In an embodiment according to method 12 of the second aspect, a real-time overview of non-validated beverage gifts or gifts for said establishments can be requested from the central server via an account associated with an establishment from the predetermined list of establishments.

As an operator of an establishment, it may be useful to encourage certain users to use a gift so that it is not lost, but also to see to what extent self-offered gifts are used or not by the recipients. In addition, it also provides the operator with an overview of the income to be expected for the coming period.

The option of dividing a gift according to method 15 of the second aspect can be particularly useful to spread a gift over an entire evening. For example, a user can gift another user to 10 pints or cokes, but are of course not expected to cash them in at once, especially since it is not easy to meet up with 9 others by a certain deadline. In this way, for example, the recipient can select one or two refreshments from the gift, split them off and convert them into a new gift (or vice versa, split the rest and convert them into a new gift), which can be converted into a representation for validation. Thus, it is possible to only use the desired refreshments in the desired number, and the other refreshments are not lost.

Furthermore, also in a possible embodiment according to the second aspect, multiple gifts for a particular user can be combined into a single gift by the user. This can be done either locally, on the application and mobile device itself, or on the central server controlled from the application. Here, however, upon validation of the (provisional) new, merged gift, a new gift would be (definitively) created on the central server, and the merged gifts marked as validated on the central server.

In a preferred embodiment according to the second aspect, the first and second user can be the same user.

The biggest advantage of this is that a user can give themselves a certain budget in advance to consume, which on the one hand can impose a certain restriction on them, but on the other hand also allows them to operate completely cashlessly when visiting the establishment.

In a preferred embodiment according to the second aspect, the validating party does not receive any information regarding the gift regarding the identity of the first user and/or the second user.

In the most preferred embodiment according to the second aspect, the sending of the information by the first user is performed by a swipe movement on a display of the mobile device on which the first user is logged in with their account on the mobile application.

1. Computer-implemented method for managing establishment-linked beverage gifts or gifts between different users, the method comprising the following steps:
a. receiving and storing information in a central server from a first user, which first user is registered with an account on a mobile application, which application is executable on a mobile device with a display, regarding a new beverage gift or gift for a second user, which information is provided via a mobile device where the first user is logged into the mobile application via their account, which information comprises at least the following data:
i. identification data of the first user, wherein the identification data may be a username of their account for the mobile application and/or telephone number, optionally wherein the identification data of the first user is automatically provided by the mobile application;
ii. identification data of the second user, wherein the identification data may be a username of their account for the mobile application and/or telephone number of the second user, which identification data of the second user is provided by the first user;
iii. establishment for validating the beverage gift or gift, the establishment being selected by the first user from a predetermined list of establishments from the central server;
iv. gift data of the beverage gift or gift comprising at least quantity, and optionally identification, of gifted refreshment units, the identification of the gifted refreshment units being selected from a predetermined refreshment list from the central server by the first user, the predetermined refreshment list being dependent on the selected establishment, and wherein it is verified that the first user has a credit of refreshment units for the selected establishment prior to the beverage gift or gift on their account on the mobile application that is at least as large as the number of refreshment units of the beverage gift or gift;
wherein the gift data is provided after selecting the establishment;
b. reducing the credit of the first user for the selected establishment by the number of gifted refreshment units;
c. after receiving the information about the beverage gift or gift for the second user, detecting from the central server the logging in of the second user into their account on the mobile application;
d. upon detection of the logging in of the second user, sending from the central server the beverage gift or gift data to the mobile device on which the second user is logged in;
e. on the basis of an order for refreshments at the establishment by the second user, by a display device on which an account is logged in that is associated with the establishment, generating an optical, machine-readable representation, preferably a QR code, which representation is displayed machine-readable for a mobile device on a display of the establishment, and which representation can be uniquely validated by a mobile device on which the account of the second user is logged in, the generated representation comprising information about the number of refreshments of the order, and the type of refreshments of the order;
f. reading in the optical representation via the mobile application on a mobile device with video capacity on which the account of the second user is logged in;
g. processing the optical representation on the mobile device on which the second user is logged in, the number of refreshment units associated with the order and/or the number of refreshments and type of refreshments being displayed on the mobile device, whereby approval is requested from the second user prior to crediting the number of refreshment units from the account of the second user to the account of the establishment;
h. after approval from the second user, communicating to the central server of the approval, wherein the credit of the second user for the selected establishment is reduced by the number of refreshment u nits of the order;
i. reporting the approval to the account of the second user and the account of the establishment, as well as updating the credit of the second user.

2. Computer-implemented method according to the preceding claim 1, wherein the display of the establishment simultaneously with the optical representation, also further shows the number of refreshment units of the order.

3. Computer-implemented method according to claim 1, wherein the credit of an account for an establishment is quantified on the basis of a whole number of refreshment units, and wherein the credit of the account is displayed when approving the crediting of the refreshment units of the order.

4. Computer-implemented method according to claim 1, wherein, when logging in to an account, the information regarding all beverage gifts or gifts linked to said account is retrieved again from the central server, preferably wherein the information is retrieved again when specifically requesting the information from said account.

5. Computer-implemented method according to claim 1, wherein an account associated with an establishment from the predetermined list of establishments is adapted to be linked to a digital accounting system, wherein an approved order from said account of the establishment is automatically passed on to the digital accounting system, which is further provided with the number of refreshments and the type of refreshments of the order.

6. Computer-implemented method according to claim 1, wherein a unique username and a unique telephone number are associated with each account, and preferably wherein a bank account number is associated with each account.

7. Computer-implemented method according to claim 1, wherein a user prepays their own initialised beverage gifts or gifts via a virtual account-linked credit, which credit can be provided with funds electronically.

8. Computer-implemented method according to claim 1, wherein the approval of the second user logged in to their account does not require identity verification.

9. Computer-implemented method according to claim 1, wherein when selecting the establishment upon initialising a beverage gift or gift by a user, the user can search the predetermined list based on geographic location.

10. Computer-implemented method according to claim 1, wherein via an account associated with an establishment from the predetermined list, the predetermined refreshment list can be edited for said establishment, wherein editing comprises adding, modifying and deleting refreshments on the refreshment list, as well as adding, modifying and deleting of the price of the aforementioned refreshments.

11. Computer-implemented method according to claim 1, wherein a user can divide a non-validated beverage gift or gift with multiple gifted refreshments into separate beverage gifts or gifts, each comprising at least one gifted refreshment, the total the number of gifted refreshments of the divided individual beverage gifts or gifts being at most equal to the number of gifted refreshments of the non-validated beverage gift or gift to be divided.

12. Computer-implemented method according to claim 1, wherein the information regarding a beverage gift or gift further comprises a timestamp.

13. Computer-implemented method according to claim 1, wherein non-validated beverage gifts or gifts received on a first account can be passed on, partially or completely, to a second account, thereby defining a new beverage gift or gift, wherein the refreshments to be transmitted and their number can be defined from the first account.

14. Computer-implemented method according to claim 1, wherein the first and second user can be the same user.
